(19) United States
(12) Patent Application Publication
(10) Pub. No.: US 2017/0069884 A1
(43) Pub. Date: Mar. 9, 2017

(54) Battery Pack Replacement System

(71) Applicant: Battery Pack Replacement System, LLC, Brandon, FL (US)

(72) Inventors: Scott Allen Beddow, Brandon, FL (US); Jerauld Joseph Polizzi, Brandon, FL (US); Mitchell Nunes, Brandon, FL (US)

(21) Appl. No.: 14/847,402

(22) Filed: Sep. 8, 2015

(51) Int. Cl. H01M 2/10; H01M 10/42

(52) U.S. Cl. CPC H01M 2/1066; H01M 10/425; H01M 2220/30

(57) ABSTRACT

A battery pack replacement system includes multiple different battery adapters that are connectable to a single AC-to-DC converter via a specially adapted power cable, and that are configured to replace the battery pack of a particular tool and provide the correct voltage to the tool.

### FIELD OF THE INVENTION

The present invention relates generally to battery operated power tools, and more particularly, relating to battery back replacement system for powering battery operated power tools using an electrical cable connected to a conventional AC electrical outlet.

### BACKGROUND OF THE INVENTION

Battery operated power tools, also known as cordless power tools, have become very popular because of the convenience of operating without a power cord plugged into an electrical outlet. Numerous battery operated power tools exist, ranging from light duty home tools to heavy duty construction tools to lawn and garden tools.

Today, most battery operated power tools use a battery back to power the tool. When the battery pack is drained, it is easily disconnected from the power tool and replaced with a charged battery pack. Once disconnected, the drained battery back can be recharged by a battery charger. Depending on the tool manufacturer and the type of tool, the battery pack is configured to supply electrical power at a certain DC voltage. For example, typical voltages include 24 Volts, 18 Volts, 14.4 Volts, and 12 Volts.

Manufacturers of battery operated power tools specifically configure their battery packs to only operate with its own tools. That is, battery packs are configured to be proprietary to a specific brand of battery operated power tool.

Although battery operated power tools provide the convenience of operating without a power cable, they have several disadvantages. For example, the battery packs have a limited amount of power and need to be recharged often, especially when heavily used. And, most battery packs require several hours to recharge, thus requiring a user to have multiple battery backs available to use the power tool for an extended period of time. Additionally, the proprietary design of the battery packs makes it expensive for a user to purchase and maintain multiple battery packs across different tool manufacturers.

There have been attempts to alleviate the some of these drawbacks. Specifically, Published U.S. Patent Application 2007/0090796 describes a power adapter for power tools that provides a power adaptor that can be plugged into an electrical outlet and replaces the battery pack of the power tool. Similarly, Published U.S. Patent Application 2011/0121782 describes an AC-to-DC converter in the form of a power adaptor replacement for the power tool battery back.

While the devices heretofore fulfill their respective, particular objectives and requirements, they do not provide a battery pack replacement system for battery operated tools that can be used with tools from different tool manufacturers as such there exists and need for a new battery pack replacement system, which substantially departs from the prior art, and in doing so provides an apparatus primarily developed for the purpose of providing electrical power replacement to different power tools each having a different battery configuration, voltage requirement or both.

### SUMMARY OF THE INVENTION

In view of the foregoing disadvantages inherent in the known types of power adaptors for battery operated tools, the present invention provides a new battery pack replacement system wherein the same can be used with tools having different battery packs, voltage requirements or both.

In general, in one aspect, battery pack replacement system includes multiple different battery adapters that are connectable to a single AC-to-DC converter via a specially adapted power cable, and that are configured to replace the battery pack of a particular tool and provide the correct voltage to the tool.

In general, in another aspect, a battery pack replacement system includes first and second battery adaptors. The first battery adaptor having a first configuration for connection to a first power tool. The second battery adaptor having a second configuration for connection to a second power tool. The first and second configurations being dissimilar. Add each of the first and second battery adaptors having a first electrical connector for connection with the electrical system of a power tool and a second electrical connector for connection with a battery adaptor power cord.

In general, in another aspect, the battery back replacement system may also include a battery adaptor power cord having a third electrical connector for connection with the second electrical connector of the first and second battery adaptors, and an AC-to-DC converter electrically connected to the battery adaptor power cord and operable to convert AC electrical power to DC electrical power for delivery to a power tool to which one of the first and second battery adaptors is mounted.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 is a diagrammatic view of a battery pack replacement system constructed in accordance with the principles of an embodiment of the present invention;

FIG. 2 is an enlarged end view of an electrical connector of the battery pack replacement system;

FIG. 3 is an electrical schematic of an exemplary AC-to-DC converter of the battery pack replacement system;

FIG. 4a is an electrical schematic of a configuration of a battery adaptor electrical connector;

FIG. 4b is an electrical schematic of a second configuration of a battery adaptor electrical connector;

FIG. 4c is an electrical schematic of a third configuration of a battery adaptor electrical connector; and

FIG. 5 is a diagrammatic in-use view of the battery pack replacement system

### DETAILED DESCRIPTION OF THE INVENTION

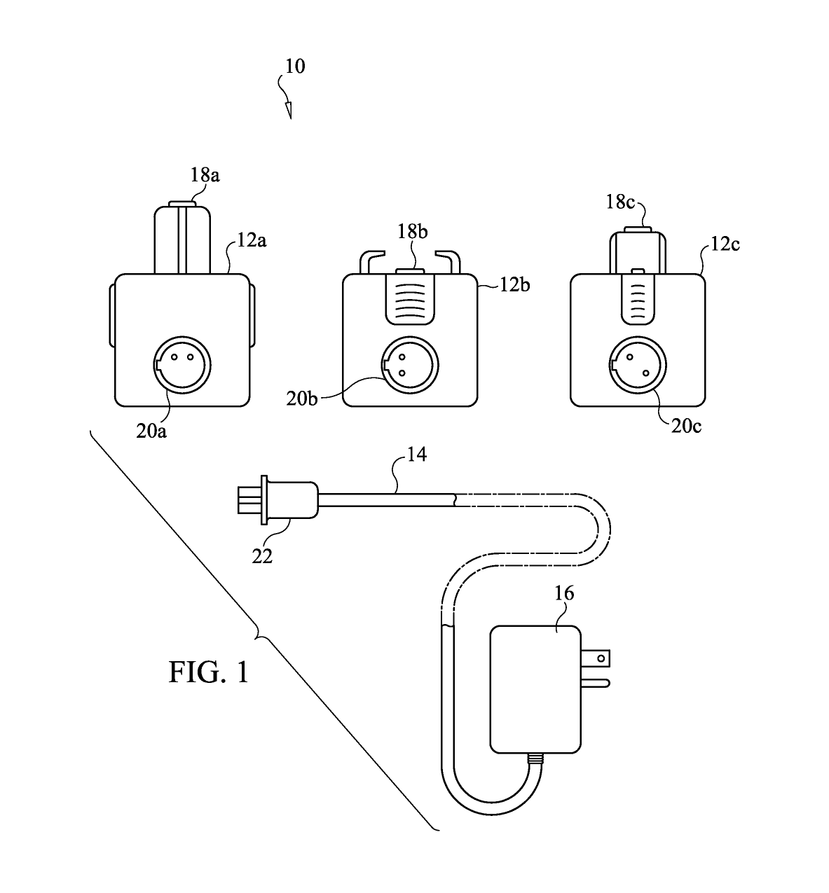

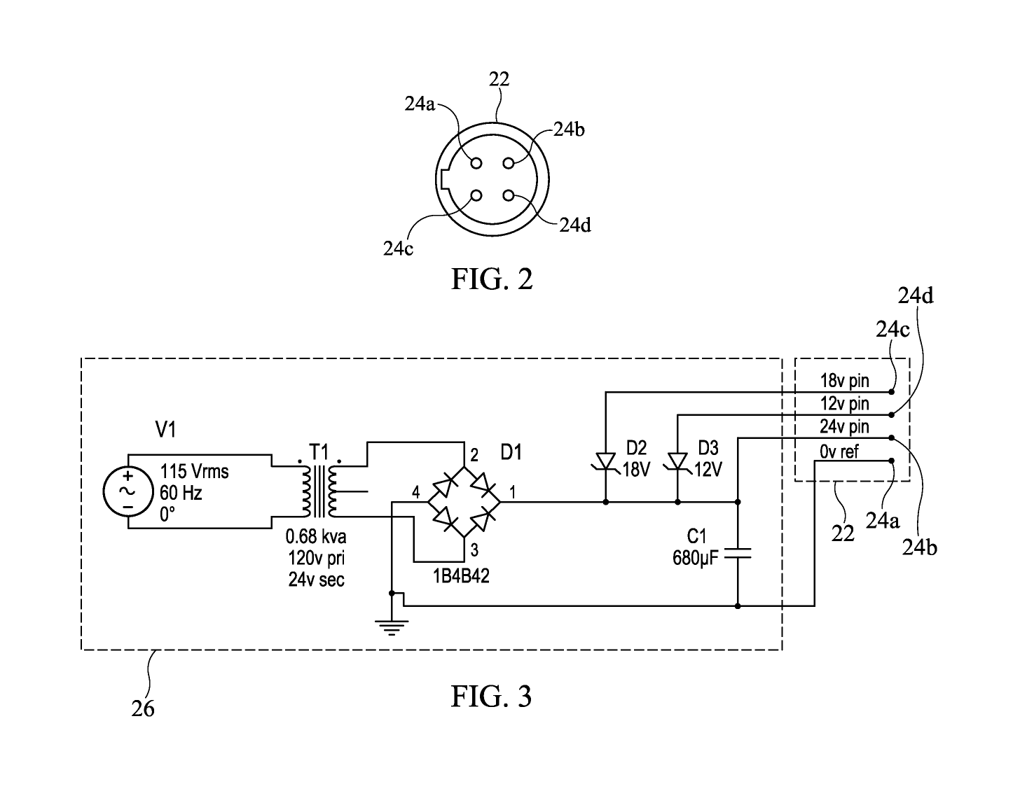

With reference to FIGS. 1 through 5, there is representatively illustrated a new battery replacement system 10 in accordance with an embodiment of the present invention. As discussed in detail below, the battery replacement system 10 is operable to provide power to different power tools each having a different battery pack configuration, operating voltage or both.

Turning specifically to FIGS. 1-3 and 4a-4c, the battery replacement system 10 includes at least two different battery adaptors, such as battery adaptors 12a-12c, a battery adaptor power cord 14, and an AC-to-DC converter 16. Each battery adaptor 12a-12c is configured to match the size and shape of a battery pack of a power tool such that the battery adaptor is connectable to the power tool in place of the power tool's battery back. That is, the battery adaptor is configured to replace the power tool's battery pack and provide a similar feel to the user. Additionally, each battery adaptor may be weighted to match the weight of the replaced battery pack to further provide an expected feel to the user.

Each battery adaptor 12a-12c includes a first electrical connector 18a-18c and a second electrical connector 20a-20c, respectively, that are electrically connected. The first electrical connector 18a-18c is configured to match the electrical connector of the power tool's battery pack and includes at least a positive and a negative electrical connection that are connected to the power tool's electrical system when the battery adaptor 12a-12c is connected to the power tool.

Power cable 14 is a multi-conductor cable and is fitted at one end with a third electrical connector 22 that is configured to cooperatively connect to each second electrical connector 20a-20c of battery adaptors 12a-12c, respectively. The opposite end of the power cable 14 is electrically connected to an AC-to-DC converter 16. The AC-to-DC converter is configured to be plugged into a standard electrical outlet and to output at least two different DC voltages. For example, the AC-to-DC converter can be configured to output 24 Volts, 18 Volts, and 12 Volts. Of course, the AC-to-DC converter can be configured to output different voltages as desired. A representative circuit diagram 26 of the AC-to-DC converter is illustrated in FIG. 3.

The AC-to-DC converter is connected to the power cable 14 such that each voltage is carried on a separate conductor and paired with a common reference voltage conductor or line. That is, in the specific illustrated example, power cable 14 is a four conductor cable where each voltage and the reference line are carried on a separate one of the four conductors of the power cable. The second connector 22 is similarly connected to the power cable 14 and includes four electrical connections 24a-24d, each connected to one of the four conductors of the cable. For example, connection 24a carries reference voltage (ground), 24b carries the 24 volt signal, 24c carries the 18 volt signal, and 24d carries the 12 volt signal (FIG. 3).

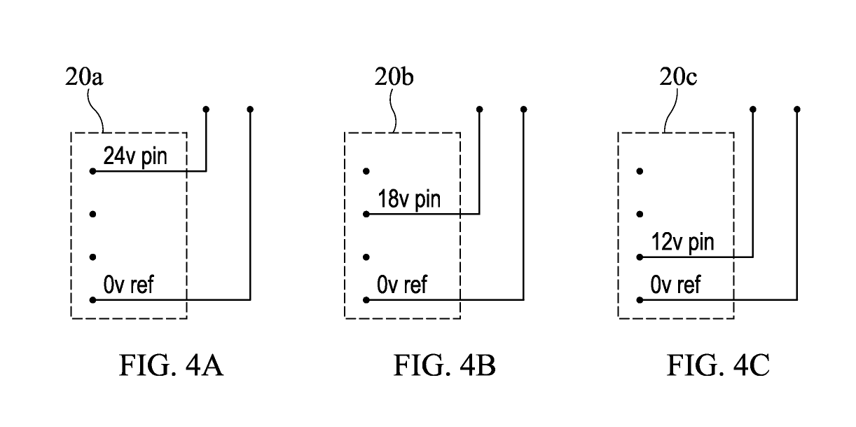

Electrical connectors 20a-20c are configured such that when connector 22 is connected to any one connector 20a-20c the correct voltage is provided to the power tool. For example, electrical connector 20a of battery adaptor 12a is configured to connect to connector 22 such that only connections 24a and 24b are electrically connected (FIG. 4a). Similarly, electrical connector 20b of battery adaptor 12b is configured to connect to connector 22 such that only connections 24a and 24c are electrically connected (FIG. 4b). And, finally, electrical connector 20c of battery adaptor 12c is configured to connect to connector 22 such that only connections 24a and 24d are electrically connected (FIG. 4C).

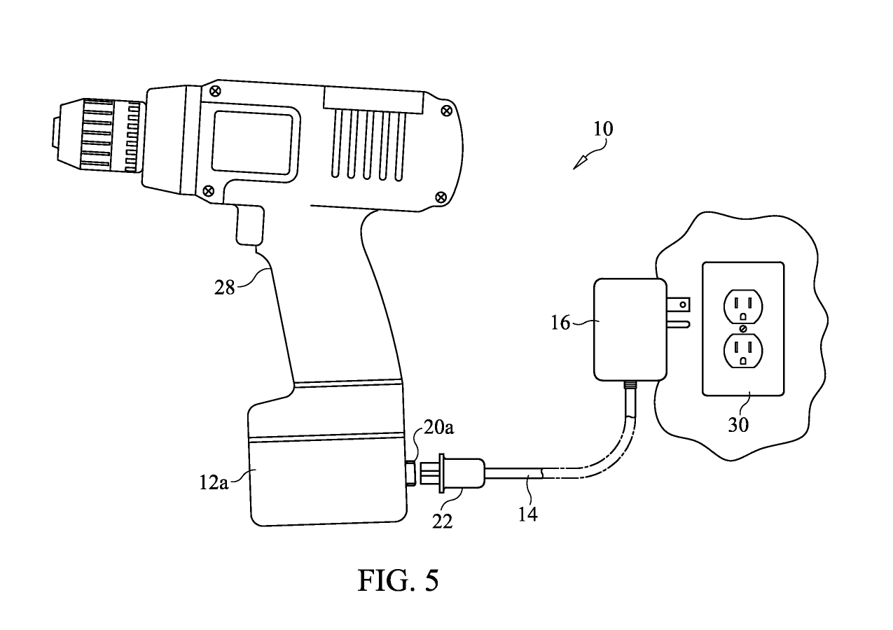

With reference to FIG. 5, it can now be understood, a user selects a battery adaptor for the specific power tool, for example battery adaptor 12a for power drill 28. Once the correct battery adaptor 12a is selected, the battery adaptor is connected to the drill 28 as a replacement of the drill's battery pack, the power cable 14 is connected to the battery adaptor, and the AC-to-DC converter is plugged into electrical outlet 30, thereby powering the drill without its battery. Similarly, once the user is done using drill 28, a second battery adaptor may be selected for a different tool and connected to electrical outlet 30 as described above.

A number of embodiments of the present invention have been described. Nevertheless, it will be understood that various modifications may be made without departing from the spirit and scope of the invention.

What is claimed is:

1. A battery pack replacement system for battery operated power tools, the battery pack replacement system comprising:
first and second battery adaptors, said first battery adaptor having a first configuration for connection to a first power tool, said second battery adaptor having a second configuration for connection to a second power tool, said first and second configurations being dissimilar, each of said first and second battery adaptors having a first electrical connector for connection with the electrical system of a power tool and a second electrical connector for connection with a battery adaptor power cord.

2. A battery pack replacement system for battery operated power tools, the battery pack replacement system comprising:
first and second battery adaptors, said first battery adaptor having a first configuration for connection to a first power tool, said second battery adaptor having a second configuration for connection to a second power tool, said first and second configurations being dissimilar, each of said first and second battery adaptors having a first electrical connector for connection with the electrical system of a power tool and a second electrical connector for connection with a battery adaptor power cord;
a battery adaptor power cord having a third electrical connector for connection with said second electrical connector of said first and second battery adaptors; and
an AC-to-DC converter electrically connected to said battery adaptor power cord and operable to convert AC electrical power to DC electrical power for delivery to a power tool to which one of said first and second battery adaptors is mounted.

3. The battery pack replacement system of claim 2, wherein:
said AC-to-DC converter operates to simultaneously output at least two different DC voltages; and
said battery adaptor power cord is a multi-conductor cable and carries each different DC voltage separately from said AC-to-DC converter to said third connector.

4. The battery pack replacement system of claim 3, wherein the second electrical connector of said first battery adaptor is connectable to said third electrical connector to receive a first DC voltage and said second electrical connector of said battery adaptor is connectable to said third electrical connector to receive a second DC voltage.

5. The battery pack replacement system of claim 2, wherein each of said first and second battery adaptors being weighted to correspond to the weight of a corresponding battery of a power tool.

6. A battery pack replacement system for battery operated power tools, the battery pack replacement system comprising:
first and second battery adaptors, said first battery adaptor being sized and shaped to correspond to the size and shape of a battery pack of a first power tool, said second battery being sized and shaped to correspond to the size and shape of a battery pack of a second power tool, said first and second battery adaptors having a different size and shape, each of said first and second battery adaptors having a first electrical connector for connection with the electrical system of a power tool and a second electrical connector for connection with a battery adaptor power cord;
a battery adaptor power cord having a third electrical connector for connection with said second electrical connector of said first and second battery adaptors; and
an AC-to-DC converter electrically connected to said battery adaptor power cord and operable to convert AC electrical power to DC electrical power for delivery to a power tool to which one of said first and second battery adaptors is mounted.

7. The battery pack replacement system of claim 6, wherein:
said AC-to-DC converter operates to simultaneously output at least two different DC voltages; and
said battery adaptor power cord is a multi-conductor cable and carries each different DC voltage separately from said AC-to-DC converter to said third connector.

8. The battery pack replacement system of claim 7, wherein said second electrical connector of said first battery adaptor is connectable to said third electrical connector to receive a first DC voltage and said second electrical connector of said battery adaptor is connectable to said third electrical connector to receive a second DC voltage.

9. The battery pack replacement system of claim 8, wherein said second electrical connector of said first battery adaptor has a pair of electrical contacts arranged in a first pattern, said second electrical connector said battery adaptor has pair of electrical contacts arranged in a second pattern, said first and second pattern being dissimilar.

10. The battery pack replacement system of claim 6, wherein each of said first and second battery adaptors being weighted to correspond to the weight of a corresponding battery of a power tool.
